(19) United States
(12) Patent Application Publication
(10) Pub. No.: US 2008/0100826 A1
(43) Pub. Date: May 1, 2008

(54) Devices For Monitoring Particulate Accumulation On A Filter And Related Methods

(76) Inventor: Richard Sharpe, Woodbridge, IL (US)

Correspondence Address: LATHROP & GAGE LC, 4845 PEARL EAST CIRCLE, SUITE 300, BOULDER, CO, 80301, US

(21) Appl. No.: 11/925,439

(22) Filed: Oct. 26, 2007

Related U.S. Application Data
(60) Provisional application No. 60/854,499, filed on Oct. 26, 2006.

(51) Int. Cl. G01J 3/00; G01N 21/00

(52) U.S. Cl. 356/51; 356/434

(57) ABSTRACT

A device and process monitors particulate accumulation proximate a surface of a filter. A radiation source generates a signal that optically couples to a detector that detects the signal. An optical window is disposed before the detector and accumulates particulate matter. A controller processes the detected signal to monitor changes in particulate accumulation on the optical window by comparing an initial measurement of the detected signal to a subsequent measurement of the detected signal. At least one output device indicates particulate accumulation. A housing assembly mounts the radiation source, the detector and the processor to an upstream surface of the filter.

### RELATED APPLICATIONS

This application claims priority to U.S. Provisional Application Ser. No. 60/854,499 filed Oct. 26, 2006, incorporated herein by reference.

### BACKGROUND

Air filtration systems are used in various environments to remove particulate matter which might otherwise pose an inhalation hazard to humans or contaminate machinery and goods. For example, air filtration systems are found in kitchens, clean rooms, mines, elevator shafts, heating and air conditioning systems and space vehicles.

It is recommended that an air filter be periodically inspected and replaced to ensure proper operation of a machine containing the air filter. For example, the Environmental Protection Agency reports that regular inspection and replacement of furnace filters reduces heating and cooling costs by up to ten percent. Such preventative maintenance has also been shown to reduce service costs, where nine out of ten heating or air conditioning system failures are caused by accumulation of dirt and dust. In spite of these facts, consumer surveys show that eighty percent of respondents do not periodically check their filters.

Several attempts have been made to develop a device that alerts a consumer when it is time to replace a filter. Some of these devices merely sound an alarm after a set period of time. Other devices detect filter clogging by monitoring air pressure and/or flow rate. See, for example, U.S. Pat. Nos. 6,993,414; 6,743,281; 6,703,937; 5,351,035; 5,036,698; 4,751,501; 4,747,364; 4,321,070; 3,916,817; 3,736,900; 3,027,865; 2,804,839; 2,782,747; 2,753,831; and 2,721,533. However, these devices may be ineffective where local conditions and/or variations in usage patterns make notification after a set time period inappropriate, or where non-filter system components interfere with the measurement of pressure and/or flow rate.

### SUMMARY

In one embodiment, a device monitors particulate accumulation proximate a surface of a filter. A radiation source generates a signal that optically couples to a detector that detects the signal. An optical window is disposed before the detector and accumulates particulate matter. A controller processes the detected signal to monitor changes in particulate accumulation on the optical window by comparing an initial measurement of the detected signal to a subsequent measurement of the detected signal. At least one output device indicates particulate accumulation. A housing assembly mounts the radiation source, the detector and the processor to an upstream surface of the filter.

In another embodiment, a method monitors particulate accumulation proximate an upstream surface of a filter and includes the steps of generating an optical signal, detecting an initial level of the optical signal, detecting at least one subsequent level of the optical signal, comparing the subsequent level to the initial level to determine a variation in particulate accumulation, and activating an alarm if the variation in particulate accumulation exceeds a predetermined threshold.

In another embodiment, a method monitors particulate accumulation proximate an upstream surface of a filter. An optical signal is generated. An initial level of the optical signal is detected; At least one subsequent level of the optical signal is detected and compared to the initial level to determine a variation in particulate accumulation. An indication of the variation in particulate accumulation is provided.

In another embodiment, a filter has a particulate accumulation monitoring device, including: a radiation source for generating a signal; a detector optically coupled to the radiation source for detecting the signal; an optical window disposed before the detector, the optical window accumulating particulate matter; a controller for processing the detected signal to monitor changes in particulate accumulation on the optical window by comparing an initial measurement of the detected signal to a subsequent measurement of the detected signal; and a housing assembly containing the radiation source, the detector and the processor, the housing assembly being integrated with an upstream surface of the filter.

### BRIEF DESCRIPTION OF THE FIGURES

FIG. 1 is a schematic diagram illustrating an air handling system that includes one exemplary particulate accumulation monitoring device on a filter, according to one embodiment.

FIG. 2 is a block diagram illustrating the particulate accumulation monitoring device of FIG. 1 in greater detail.

FIG. 3 is a flowchart illustrating one exemplary process for monitoring particulate accumulation on a filter.

FIG. 4 shows an isometric view of one exemplary particulate accumulation monitoring device.

FIG. 5 shows an alternate isometric view of the device of FIG. 4.

FIG. 6 shows a bottom isometric view of the device of FIGS. 4 and 5.

FIG. 7 shows a top isometric view of one exemplary particulate accumulation monitoring device with an embedded channel.

FIG. 8 shows a top view of one exemplary particulate accumulation monitoring device.

FIG. 9 shows a front view of the exemplary placement of the particulate accumulation monitoring device of FIG. 1 on a filter.

FIG. 10 shows a side view of the device and filter of FIG. 9.

FIG. 11 shows a front view of one exemplary particulate accumulation monitoring device integrated with a filter.

FIG. 12 shows a front view of one exemplary particulate accumulation monitoring device integrated with a filter.

### DETAILED DESCRIPTION OF THE FIGURES

As discussed in more detail below, devices disclosed herein optically monitor particulate accumulation on an air filter, without interference from non-filter system components.

In the attached drawings, like numbers represent similar elements in multiple figures. Numbering without parentheses is used to denote a genus (e.g., device 102), whereas numbering with parentheses denotes a species within a genus (e.g., device 102(2)). These drawings may not be drawn to scale.

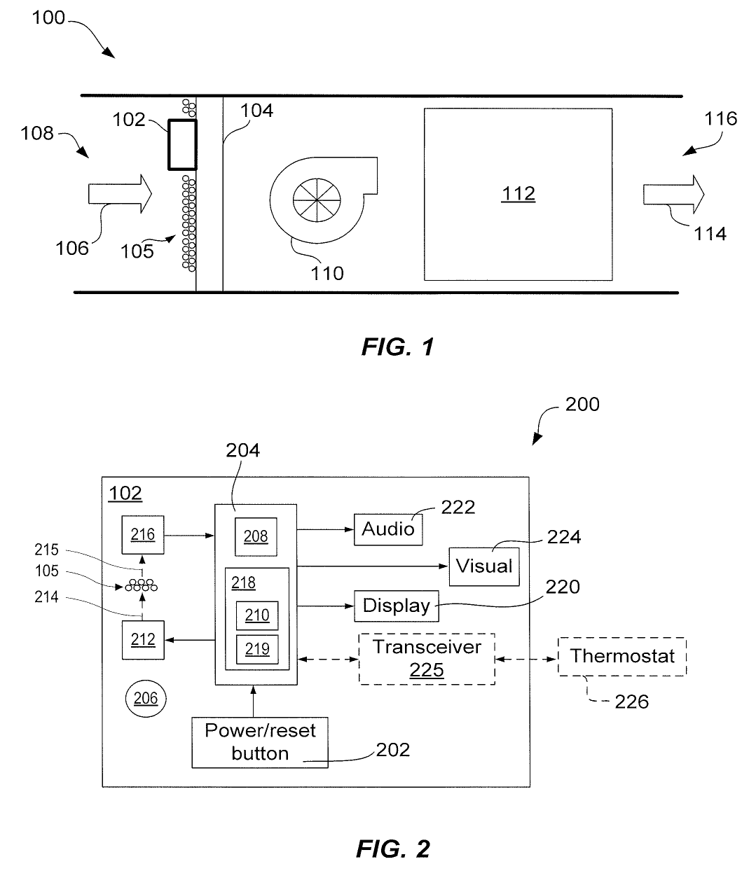

FIG. 1 is a schematic diagram illustrating one exemplary air handling system 100 that includes a particulate accumulation device 102 for monitoring particulate accumulation 105 on a filter 104. Incoming airflow 106 is drawn into system 100 through an inlet 108 by a fan 110. Filter 104 is disposed between inlet 108 and fan 110 to remove particulate matter from incoming airflow 106. A heat exchanger 112 heats or cools the air as it flows through system 100 and the air, indicated as outgoing airflow 114, exits system 100 through an outlet 116. Air filter 104 may be replaced periodically to avoid filter clogging that may decrease airflow (e.g., airflows 106 and 114) through system 100, thereby increasing the workload of fan 110 and decreasing the efficiency of heat exchanger 112. The particulate accumulation devices and methods described herein are suitable for monitoring particulate accumulation 105 in system 100 and similar environments.

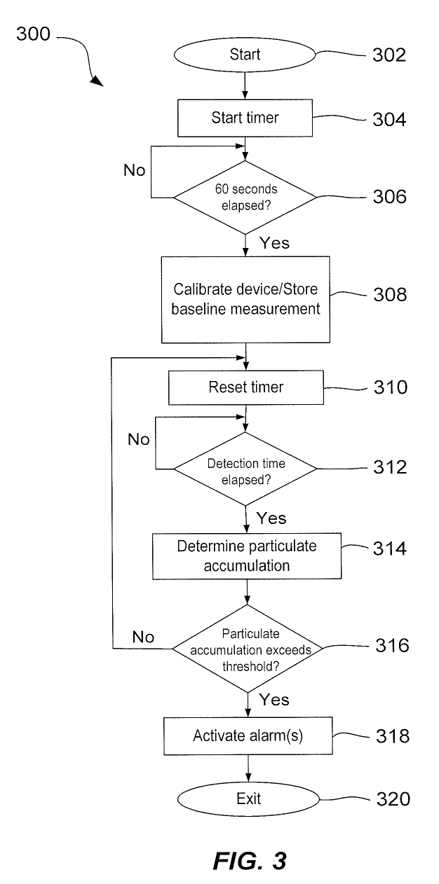

FIG. 2 is a block diagram 200 illustrating particulate accumulation device 102, FIG. 1, in greater detail. Device 102 is activated by a power/reset button 202 and controlled by a controller 204. Device 102 may be powered by one or more batteries 206 housed within device 102; alternatively, power may be provided to device 102 by other sources, such as those powering other elements of system 100, FIG. 1, and an external power supply. Controller 204 includes a memory 218 and a processor 208 for executing software 210, which may implement a process 300, shown in FIG. 3. In operation, processor 208 controls a radiation source 212 that transmits a signal 214 towards a detector 216. Signal 214 passes through particulate accumulation 105 and emerges as attenuated signal 215. Detector 216 detects attenuated signal 215 and sends it to processor 208 where it is digitized and stored as raw data 219 within memory 218. For example, processor 208 may include an analog-to-digital converter and/or a comparator. Comparison of an initial signal level to one or more subsequent signal levels provides an indication of signal attenuation due to the accumulation of particulate matter 105. Device 102 includes a display 220 for displaying an indication of particulate accumulation, for example, as text showing a level (e.g., low, medium or high) or as a percentage of a desired maximum particulate accumulation. When particulate accumulation 105 exceeds a predetermined threshold, controller 204 may activate an audio alarm 222 and/or a visual alarm 224. In one example, audio alarm 222 sounds for thirty seconds every eight hours and/or visual alarm 224 activates once per minute. Such intermittent alarm activation may preserve battery life. In another example, audio output of alarm 222 or visual output of alarm 224 increases in intensity or frequency with increasing particulate accumulation. Power/reset button 202 may deactivate and reset the alarm(s) 222, 224. If the power/reset button 202 is depressed without removing accumulated particulate matter from detector 216, device 102 adjusts the threshold to a higher value so that more particulate accumulation is tolerated before activation of alarms 222, 224. On the other hand, if particulate matter is removed from detector 216, device 102 assumes that a new filter (e.g., filter 104) has been installed. It recalibrates a baseline value for signal 215 received by detector 216 and recommences operation to monitor accumulation of particulate matter 105.

In one embodiment, device 102 communicates, either through a hardwired connection or wirelessly using an optional transceiver 225, with a thermostat 226. Thermostat 226 is for example placed at a centralized location within a residence or commercial building and includes one or more of an audio alarm, a visual alarm or a display for providing an indication of particulate accumulation 105 on filter 104. Device 102 may also receive input from thermostat 226, such as a user command to display an instantaneous particulate accumulation measurement or a command to reset device 102.

FIG. 3 shows one exemplary process 300 for monitoring particulate accumulation 105 on filter 104, FIG. 1. Process 300 may be implemented by use of software 210 within processor 208. Process 300 begins at step 302, and a timer is started in step 304. Step 306 is a decision. If, in step 306, a set period (e.g., sixty seconds) has elapsed, process 300 continues with step 308; otherwise process 300 continues with step 306. This sixty second delay allows a user to activate device 102 and insert filter 104 into its operational environment prior to the step of calibration (i.e., calibration then occurs in the operational location). In step 308, device 102 calibrates itself and a baseline measurement of signal 215, detected by detector 216, is stored in memory 218. This baseline measurement may represent a zero particulate accumulation level. In one example of step 308, processor 208 controls radiation source 212 to generate signal 214 such that input to processor 208 from detector 216 is at a level that is 50% of the digitizing range of processor 208. The timer is then reset instep 310. Step 312 is a decision. If, in step 312, a set amount of time between detection events has elapsed, process 300 continues with step 314; otherwise process 300 continues with step 312. Steps 310 and 312 thus implement a delay that represents a particulate measurement interval. For example, device 102 is programmable or pre-set to measure particulate accumulation after a period of time selected from an hour, a number of hours, a half day, a day, a number of days, a week and a month. In a preferred embodiment, a detection event occurs every twelve or twenty-four hours. In step 314, particulate accumulation is determined. In one example of step 314, processor 208 controls radiation source 212 to transmit signal 214 toward detector 216; detector 216 then detects attenuated signal 215 and sends the detected signal to processor 208 where it is digitized and stored as raw data 219. The intensity, or value, of raw data 219 is inversely proportional to the amount of particulate accumulation. A predetermined threshold level is set at a certain amount of particulate accumulation and raw data 219, obtained in step 314, is analyzed in step 316 to determine whether or not the current level of particulate accumulation exceeds the predetermined threshold. The threshold level is for example pre-set or re-set as described with respect to FIG. 2. In one embodiment, once device 102 is calibrated, radiation source 212 operates only during measurements of particulate accumulation. A particulate accumulation threshold level may be set at 25% above the zero accumulation level (i.e., baseline reading) obtained in step 308, thereby representing a certain particulate accumulation. The particulate accumulation threshold level may be set according to a manufacturer's specifications or it may be programmed by a user of the device via a user input (not shown). For example, a user may press a button prior to changing a filter to set a desired maximum amount of particulate accumulation. If the accumulation level determined in step 314 does not exceed the threshold accumulation level, process 300 continues with step 310; otherwise process 300 continues with step 318, in which processor 208 activates the audio and/or visual alarm(s) 222, 224. In one embodiment, an additional decision step may be inserted in process 300 prior to step 318 to determine whether or not the particulate accumulation level has exceeded the threshold level a certain number of times. This decision would increase reliability of detection by ensuring that particulate accumulation is in excess of the predetermined level before activating the alarm(s). Process 300 ends with step 320.

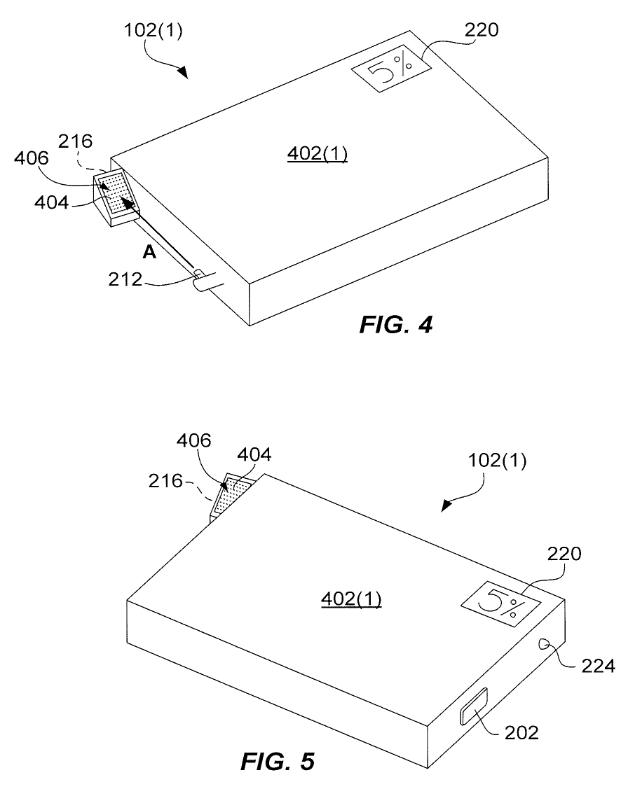

FIG. 4 shows an isometric view of a particulate accumulation monitoring device 102(1). Device 102(1) includes a housing 402(1) from which radiation source 212 and detector 216 protrude. A direct line of sight, indicated by arrow A, is maintained between radiation source 212 and detector 216. Detector 216 may be one or more of a photodiode, microbolometer or CCD, that is enclosed by or disposed behind an optical window 404. In an embodiment, radiation source 212 is a monochromatic light emitting diode (LED). When radiation source 212 is an infrared source, optical window 404 may be fabricated from any material that is transparent to infrared radiation, such as quartz, sapphire, silicon, germanium, calcium fluoride or zinc selenide.

Optical window 404 is disposed at an approximately forty-five degree angle relative to the direction of airflow through filter 104. This orientation provides a surface 406 upon which particles may accumulate. As particles accumulate on surface 406 of optical window 404, the amount of radiation (e.g., signal 215) detected by detector 216 decreases, resulting in a corresponding decrease in the electrical signal sent from detector 216 to processor 208. This decrease may or may not have a linear relationship to the amount of particulate accumulation. In one example, processor 208 processes signal 215 to determine a percent particulate accumulation on surface 406, and transmits a corresponding display signal to display 220.

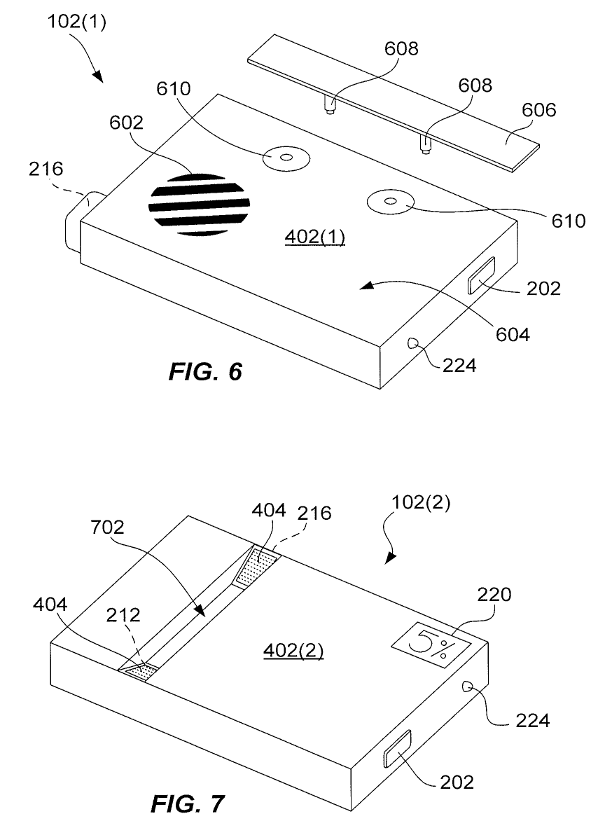

FIG. 5 shows an alternate isometric view of particulate accumulation monitoring device 102(1) of FIG. 4, illustrating power/reset button 202 and visual alarm 224. Visual alarm 224 may be an LED. FIG. 6 shows a bottom isometric view of device 102(1) of FIGS. 4 and 5. A speaker opening 602 for audio alarm 222 is shown on a back surface 604 of housing 402(1). Device 102(1) may attach to a filter 104 by a housing assembly including an attachment bar 606 and housing 402(1). Male connectors 608 of attachment bar 606 join with female connectors 610 of housing 402(1) from opposite sides of filter 104 to secure device 102(1) to the filter. That is, male connectors 608 penetrate filter 104 to connect with female connectors 610.

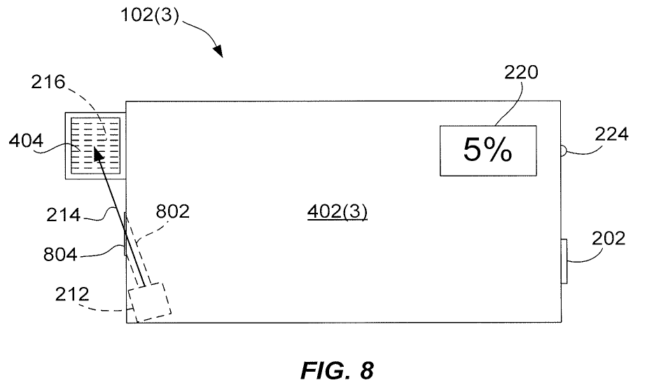

FIG. 7 shows a top isometric view of an exemplary embodiment of a particulate accumulation monitoring device 102(2) having an embedded channel 702 containing radiation source 212 and detector 216. Channel 702 may protect radiation source 212 and detector 216 from damage or breakage. An optical window 404 over radiation source 212 may prevent uneven diffraction of radiation and facilitate cleaning of the radiation source component. Since radiation source 212 and detector 216 do not protrude from housing 402, device 102 may integrate more easily with surrounding components. Channel 702 may be open or backed by mesh that allows airflow therethrough. In an alternate embodiment, channel 702 is closed to airflow by housing 402(2).

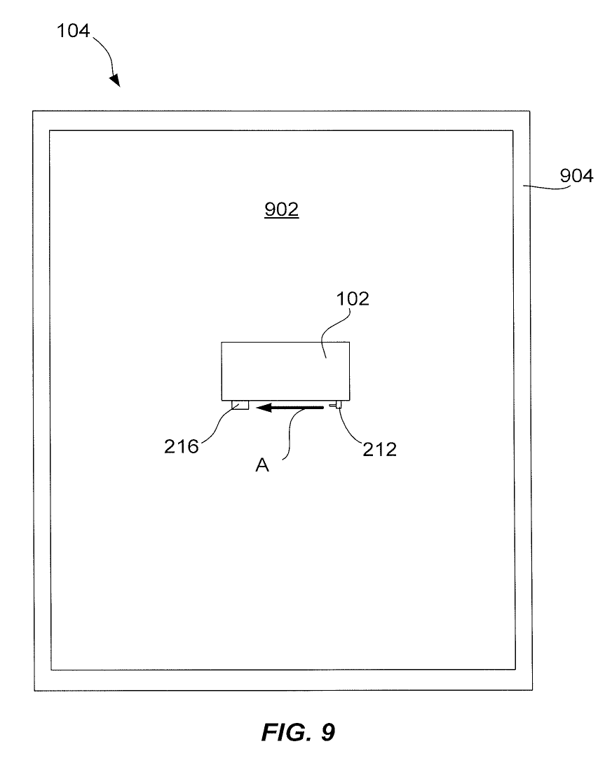

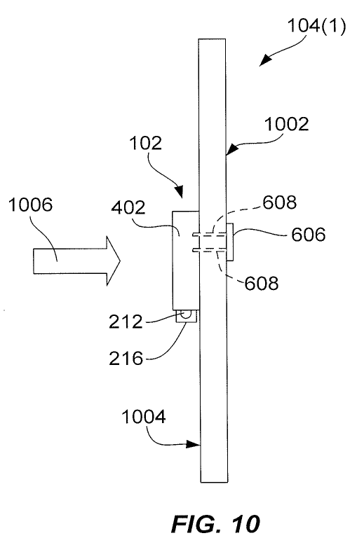

Orientation of display 220, radiation source 212 and detector 216 for each embodiment may vary without departing from the scope hereof. For example, although radiation source 212 and detector 216 are shown on a side of housing 402(1), these components may also be located both at the top and both at the bottom (see FIGS. 9 and 10).

FIG. 8 shows a top plan view of an exemplary embodiment of a particulate accumulation monitoring device 102(3) for a filter. Radiation source 212 is contained within housing 402(3), such that signal 214 may be transmitted toward detector 216 through a slot 802 and/or a window 804 within housing 402(3). Positioning of radiation source 212 within housing 402(3) may simplify manufacturing and improve airflow onto detector 216.

FIGS. 9-12 provide further details of the placement of particulate accumulation monitoring devices 102. FIG. 9 shows a front view illustrating exemplary placement of device 102 on filter 104. FIG. 10 shows a side view of device 102 and filter 104 in the embodiment of FIG. 9. FIGS. 9 and 10 are best viewed together with the following description. Filter 104 consists essentially of an air permeable mesh 902 disposed within a frame 904. Mesh 902 may, for example, be fabricated of metal, paper or plastic fibers, while frame 904 is generally cardboard, metal or plastic. Male connectors 608 of attachment bar 606 penetrate mesh 902 from a downstream surface 1002 of filter 104 and connect with female connectors 610 of housing 402 thereby attaching device 102 to filter 104. So located, device 102 optically monitors particulate accumulation proximate to the surface of filter 104 by transmitting radiation along a direct line of sight, indicated by arrow A between radiation source 212 and detector 216, and thus in a direction that is approximately parallel to filter surface 1004. As used herein, the term “proximate” refers to a position that is within about 3 cm of the upstream surface 1004 of filter 104. In a preferred embodiment, a proximate position is within about 1 cm of surface 1004.

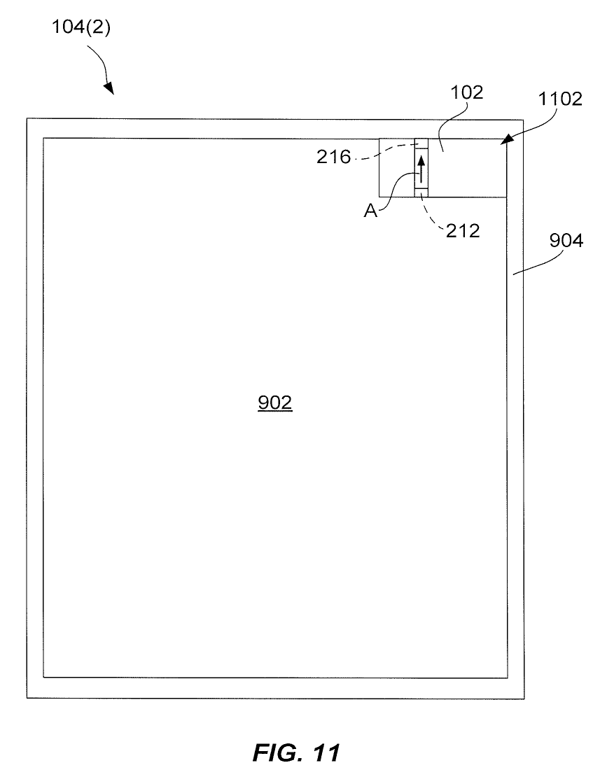

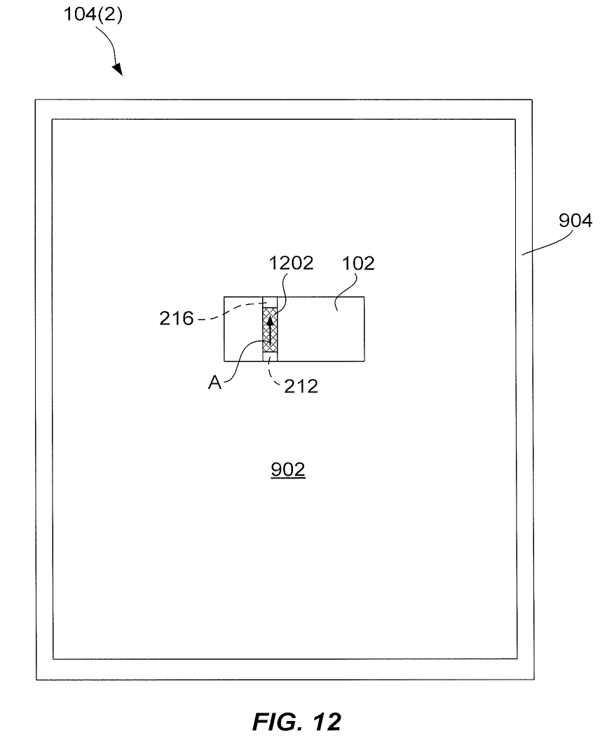

As shown in FIGS. 11 and 12, device 102 may be integrated into filter 104(2). For example, device 102 may be disposed at an internal corner 1102 of frame 904, or device 102 may be disposed at a location within mesh 902. It will be appreciated that such integrated systems may benefit from a device design such as that illustrated in FIG. 7, where radiation source 212 and detector 216 are within the confines of housing 402, and channel 702 contains a mesh backing 1202.

The orientation and placement of device 102 within or on filter 104 may vary without departing from the scope hereof.

Changes may be made in the above methods and devices without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present devices and methods, which, as a matter of language, might be said to fall there between.

What is claimed is:

1. A device for monitoring particulate accumulation proximate a surface of a filter, comprising:
a radiation source for generating a signal;
a detector optically coupled to the radiation source for detecting the signal;
an optical window disposed before the detector, the optical window accumulating particulate matter;
a controller for processing the detected signal to monitor changes in particulate accumulation on the optical window by comparing an initial measurement of the detected signal to a subsequent measurement of the detected signal;
at least one output device for indicating particulate accumulation; and
a housing assembly for mounting the radiation source, the detector and the processor to an upstream surface of the filter.

2. The device of claim 1, wherein the radiation source is selected from the group comprising a monochromatic LED and an infrared LED.

3. The device of claim 2, wherein the optical window is fabricated from a material selected from the group consisting of quartz, sapphire, silicon, germanium, calcium fluoride and zinc selenide when the radiation source is the infrared LED.

4. The device of claim 1, the controller comprising a processor for processing the detected signal and a memory for storing the detected signal as raw data.

5. The device of claim 1, the at least one output device comprising an alarm for indicating to a user of the device when the particulate accumulation exceeds a predetermined threshold.

6. The device of claim 5, the alarm comprising one or more of an audio alarm and a visual alarm.

7. The device of claim 1, the at least one output device comprising a display for indicating particulate accumulation.

8. The device of claim 1, further comprising a reset button for instructing the controller to calibrate particulate accumulation measurements based upon the signal.

9. The device of claim 1, wherein the housing assembly includes an attachment bar.

10. The device of claim 1, further comprising a transceiver for transmitting particulate accumulation to a thermostat, the thermostat displaying the particulate accumulation.

11. A method of monitoring particulate accumulation proximate an upstream surface of a filter, comprising:
generating an optical signal;
detecting an initial level of the optical signal;
detecting at least one subsequent level of the optical signal;
comparing the subsequent level to the initial level to determine a variation in particulate accumulation; and
activating an alarm if the variation in particulate accumulation exceeds a predetermined threshold.

12. The method of claim 11, wherein the optical signal is approximately parallel to the upstream surface of the filter.

13. The method of claim 11, wherein the detection of the subsequent level occurs after a period of time selected from an hour, a number of hours, a half day, a day, a number of days, a week and a month.

14. The method of claim 11, further comprising providing an indication of the variation in particulate accumulation.

15. The method of claim 14, the step of providing an indication comprising one or more of:
displaying the variation on a display;
generating an audio signal that increases in intensity and/or frequency with increasing particulate accumulation; and
generating a visual signal that increases in intensity and/or frequency with increasing particulate accumulation.

16. The method of claim 11, further comprising deactivating the alarm and resetting the initial level of the optical signal when a reset button is pressed.

17. A method of monitoring particulate accumulation proximate an upstream surface of a filter, comprising:
generating an optical signal;
detecting an initial level of the optical signal;
detecting at least one subsequent level of the optical signal;
comparing the subsequent level to the initial level to determine a variation in particulate accumulation; and
providing an indication of the variation in particulate accumulation.

18. The method of claim 17, wherein the optical signal is approximately parallel to the upstream surface of the filter.

19. The method of claim 17, wherein the detection of the subsequent level occurs after a period of time selected from an hour, a number of hours, a half day, a day, a number of days, a week and a month.

20. The method of claim 17, further comprising activating an alarm if the variation in particulate accumulation exceeds a predetermined threshold.

21. The method of claim 20, further comprising deactivating the alarm and resetting the initial level of the optical signal.

22. The method of claim 17, wherein the indication is selected from the group consisting of text on a display, an audio signal that increases in intensity or frequency with increasing particulate accumulation and a visual signal that increases in intensity or frequency with increasing particulate accumulation.

23. A filter with a particulate accumulation monitoring device, comprising:
a radiation source for generating a signal;
a detector optically coupled to the radiation source for detecting the signal;
an optical window disposed before the detector, the optical window accumulating particulate matter;
a controller for processing the detected signal to monitor changes in particulate accumulation on the optical window by comparing an initial measurement of the detected signal to a subsequent measurement of the detected signal; and
a housing assembly containing the radiation source, the detector and the processor, the housing assembly being integrated with an upstream surface of the filter.

24. The device of claim 23, further comprising an alarm for indicating to a user of the filter when the particulate accumulation exceeds a predetermined threshold.

25. The device of claim 23, further comprising a reset button for instructing the processor to replace the initial measurement with a new measurement.
